(19) United States
(12) Patent Application Publication
(10) Pub. No.: US 2009/0289397 A1
(43) Pub. Date: Nov. 26, 2009

(54) Forming Station of Apparatus for Making Packaging

(75) Inventor: William Kleemeier, New Hope, PA (US)

Correspondence Address: HOWSON & HOWSON LLP, 501 OFFICE CENTER DRIVE, SUITE 210, FORT WASHINGTON, PA, 19034, US

(73) Assignee: PIA-K ENTERPRISES, LLC, Buckingham, PA (US)

(21) Appl. No.: 12/124,802

(22) Filed: May 21, 2008

(51) Int. Cl. B29C 51/06

(52) U.S. Cl. 264/571; 425/145

(57) ABSTRACT

An apparatus and method are provided for forming a sheet of thermoformable stock material into a desired shape on a relatively-small and relatively-inexpensive “table top” version of a thermoforming and/or vacuum forming machine. Unlike conventional machines that utilize external electric or gas powered air compressors and/or separate electric vacuum pumps, the apparatus integrates a compressed fluid/suction generating device within the machine itself so that the need to connect the machine to an external source of compressed fluid or vacuum is eliminated.

### BACKGROUND OF THE INVENTION

The present invention relates to an apparatus and method for thermoforming and/or vacuum forming thermoplastic materials, and more particularly, the present invention relates to a forming station used to form packaging products and the like from sheets of thermoplastic material.

Thermoforming and vacuum forming are known techniques used to produce packaging products for the pharmaceutical, neutraceutical, medical device, food, consumer goods, and other industries from a variety of thermoplastics and like materials. The packaging is produced in a variety of sizes and shapes, and examples of such packaging include, for instance, solid-dose pharmaceutical packaging, containers for liquid-dose packaging, food trays, and packages for batteries and other consumer articles. Typically, these types of packaging are created using vacuum forming, air-pressure forming, and mechanical molding techniques and/or a combination of these techniques.

Conventional thermoforming and/or vacuum forming machines used to produce packaging materials are relatively expensive and have a relatively large foot print requiring a considerable amount of floor space. These machines utilize compressed air from electric or gas powered generators and vacuum generated by an electric vacuum pump or compressed air vacuum generator. Many machines also include a plug assist mechanism for producing packaging requiring deep drawing of the thermoplastic material.

A thermoforming and/or vacuum forming machine used to make packaging products typically will include at least some or all of the following: a thermoforming material presentation station or area; a thermoforming material heating station or area; a forming station or area; a filling station or area; a lid stock presentation station or area; a lid stock printing station; a package sealing station; a material advance station; a trimming or cutting station; and a package discharge station. Some machines also include other stations, for example, a product verification station, a package perforation station, a package punch station, a barcode verification station, and an excess material take-up station. Of all the stations listed above, the package forming station is the most critical station of the machine.

A problem with many thermoforming and vacuum forming machines is that the machines require the use of, and connection to, external sources of compressed air typically supplied by an electric or gas powered air compressor. This adds expense to the system and prevents use of the equipment in locations that do not have a sufficient external source of compressed air. These compressors create considerable noise when operated, and thus, add further cost in connection with the need to suppress noise for providing an acceptable work environment.

In addition, most machines require a vacuum pump provided as an electric vacuum pump or an air powered vacuum generator. The need for the electric vacuum pump adds cost to the system, and the air powered vacuum generator requires compressed air and is also very loud adding cost to suppress the noise for an acceptable work environment.

Further, many machines require use of a mechanical plug assist mechanism in the forming process. Although such mechanisms assist in creating deeper packages, they also require compressed air, vacuum, or both. This requires additional parts for the equipment thereby raising the cost and complexity of the machine and replacement tooling.

Finally, various types of packaging materials tend to stick to the wall of the mold or form and make it difficult to eject the formed package from the mold. Mechanical devices such as ejector pins and the like are typically required to eliminate this problem. However, this adds more parts to the equipment and increases the cost of the machine and replacement tooling.

By way of example, the following patents disclose thermoforming and vacuum forming machines, in general: U.S. Pat. No. 4,057,382 issued to Yamamori; U.S. Pat. No. 7,293,976 B2 issued to La Sorda; U.S. Pat. No. 6,257,866 B1 issued to Fritz et al.; U.S. Pat. No. 5,641,524 issued to Rush et al.; U.S. Pat. No. 5,314,324 issued to Wendt; U.S. Pat. No. 3,767,349 issued to Jezuit; U.S. Pat. No. 4,360,334 issued to Kiefer; U.S. Pat. No. 6,010,323 issued to Sekino; U.S. Pat. No. 5,225,213 issued to Brown et al.; U.S. Pat. No. 5,162,124 issued to Hausler et al.; U.S. Pat. No. 4,878,826 issued to Wendt; U.S. Pat. No. 5,176,609 issued to Wedler et al.; and U.S. Pat. No. 3,808,772 issued to Turtschan.

Although the machines disclosed by the above referenced patents may be satisfactory for their intended purpose, there is a need for a forming station of a thermoforming and/or vacuum forming machine that does not require use of, or connection to, an external source of compressed air or vacuum. Preferably, the forming station should be inexpensive to manufacture and maintain and should be relatively quiet in operation. In addition, preferably the forming station should be provided in a relatively-compact, portable, and self-contained form and should be capable of providing a so-called “table top” version of a package forming machine.

### BRIEF SUMMARY OF THE INVENTION

The present invention is directed to an apparatus and method for forming a sheet of thermoformable stock material into a desired shape on a relatively-small and relatively-inexpensive “table top” version of a thermoforming and/or vacuum forming machine. Unlike conventional machines that utilize external electric or gas powered air compressors and/or separate electric vacuum pumps, the present invention integrates a compressed fluid/suction generating device within the machine itself so that the need to connect the machine to an external source of compressed fluid or vacuum is eliminated.

According to a preferred embodiment, a compressed air/suction generating device includes a piston moveable within a sealed cylinder that defines chambers within opposite ends of the cylinder. The chambers include ports that communicate via valves with air ports in upper and lower forms, or molds, of the machine. Thus, movement of the piston within the cylinder is used to generate an air blast, a vacuum, or both. For example, as the piston moves toward one end of the cylinder, an air blast is delivered via the chamber having a reduced volume and a vacuum is simultaneously drawn via the opposite expanding chamber. This enables equalization of the push/pull on the thermoplastic sheet sealed between opposite upper and lower forms. Also, when the piston is moved in an opposite resetting direction, the generated air blast can be used to eject the molded thermoplastic sheet from the mold.

### BRIEF DESCRIPTION OF THE DRAWING

The present invention should become apparent from the following description when taken in conjunction with the accompanying drawing, in which:

FIG. 1 is a cross-sectional view of a forming station having a self-contained compressed gas/vacuum generator according to the present invention.

### DETAILED DESCRIPTION OF THE INVENTION

The present invention is directed to an apparatus 10 and a method for forming product packaging or like material from a relatively-planar sheet 12 of stock material. The sheet material 12 is typically made of a thermoplastic or like material and is provided in individual elongate sheet form or in the form of a continuous, indefinite length, spiral roll. The apparatus 10 can comprise a “forming station” of a larger multi-station machine or can be provided and used as a stand-alone forming machine.

According to one contemplated embodiment, the apparatus 10 has a relatively small footprint and provides a so-called “table top” version of a forming station requiring only a minimum of table top surface area or floor space. Such a table-top version is compact and portable and can be used and operated at any location, including non-industrial locations such as laboratories, testing facilities, product development workshops, small offices, hospitals, pharmacies, prisons, long-term care facilities, residential dwellings, and the like. Of course, the apparatus 10 can also form part of a typical, relatively-large, industrial-sized thermoforming and vacuum forming machine. Accordingly, the apparatus 10 can be owned and operated by individuals and small companies as well as large companies.

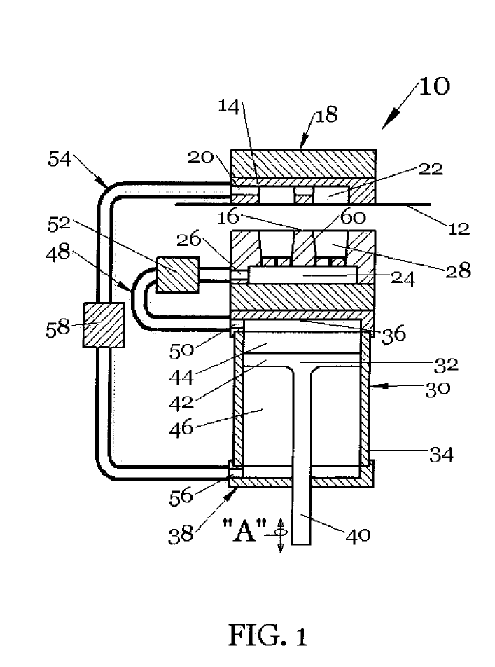

In most cases, a package forming machine will include a thermoforming material presentation station (not shown) that stages the thermoplastic sheet material 12, either in sheet or roll form, to a material heating station (also not shown). The heating station typically uses either contact or non-contact heating and heats the material 12 to a predetermined temperature required for proper forming/molding. According to the present invention, after the material 12 is heated it is moved into the forming station apparatus 10 illustrated in FIG. 1.

The forming station 10 of the present invention includes at least an opposed pair of forms, or molds parts, 14 and 16, that can be disposed in open and closed positions. In the open position, the forms 14 and 16 are spaced-apart from one another thereby permitting the sheet material 12 to be positioned between or advanced relative to the forms, 14 and 16, and/or molded portions of the sheet material 12 to be discharged from the forms, 14 and 16. In the closed position, the forms 14 and 16 can be brought into a fluid-tight engagement with the opposite faces of the sheet material 12 so that the sheet material 12 can be forced into engagement with at least one contoured mold cavity surface of at least one of the forms, 14 and 16, such as by air blast, suction, or both.

In the illustrated embodiment, the mold parts include an upper form 14 and a lower form 16. However, this simply provides one possible arrangement and other molding arrangements can also be utilized, such as the use of more then two forms or using forms disposed laterally or at an angle to the horizontal or vertical.

In FIG. 1, the upper form 14 is supported on a form mount 18 and has a port 20 in fluid communication with a void area 22 within the upper form 14, and the lower form 16 is supported on a form mount 24 and has a port 26 in fluid communication with a void area 28 within a mold cavity of the lower form 16. The forms, 14 and 16, are further supported on framing or like machine structure (not shown) that holds these items in place, for instance, as shown in FIG. 1.

By way of example, the upper form 14 can be mounted in a stationary condition, and the lower form 16 can be movable toward and away from the upper form 14 into the open and closed mold positions. The lower form 16 may be moved into place, for instance, via a manually operated or automatic mechanical, electro-mechanical, or hydraulic mechanism (not shown). Of course, various modifications can be made to this arrangement. For example, the upper form 14 can be movable relative to a stationary lower form 16, or both forms, 14 and 16, can be moveable relative to each other.

An important aspect of the present invention is that the forming station apparatus 10 has a self-contained, integral, compressed fluid/vacuum generator 30. By way of example, the fluid can be a gas, a liquid, a gel, or other type of flowable material. In a preferred embodiment as discussed below, the fluid is air; however, this aspect of the present invention can be readily altered.

The generator 30 is integrally connected to the structure of apparatus 10, such as to the mount 24 of the lower form 16 as shown in FIG. 1. However, the generator 30 could be connected to the upper form 14 or any other structural component, such as a framing component, of the forming station apparatus 10.

The preferred embodiment of the generator 30 includes a cylinder piston 32 contained within a hollow cylinder body 34 having opposite closed end walls, 36 and 38. Preferably, the cylinder body 12 has a substantially circular cross-section; however, as an alternative, the hollow body can be provided with an oval, triangular, square, multi-sided or other shaped transverse cross-section and is not limited to a circular cross-section.

The piston 32 includes a longitudinally-extending stem 40 extending through the end wall 38 in a sealed, fluid-tight manner and a transversely-extending sealing plug 42 that engages an inner surface of the sidewalls of the hollow cylinder body 34 in a fluid-tight manner thereby defining opposite hollow chambers, 44 and 46, within the cylinder body 34 on opposite sides of the sealing plug 42. Accordingly, a first chamber 44 within the cylinder body 30 is located adjacent the end wall 36 and a second chamber 46 is located adjacent the end wall 38. These chambers, 44 and 46, are sealed from one another by engagement of the sealing plug 42 of the piston 32 with the inner surfaces of the sidewalls of the cylinder body 34.

The piston 32 is movable back and forth in a longitudinal direction “A” within the hollow cylinder body 34. This movement causes the volume and size of one of the chambers, 44 or 46, to be reduced while simultaneously increasing the volume and size of the other chamber, 44 or 46, by a substantially equal amount. Movement of the piston 32 can be provided via engagement of the stem 40 of the piston 32 with a mechanical, electromechanical, or hydraulic mechanism (not shown). This mechanism can be the same or a different mechanism used to move the forms, 14 and 16, into the open and closed positions.

A hose or like conduit 48 connects a port 50 of the first chamber 44 of the cylinder body 34 in fluid communication with the port 26 of the lower form 16 via a valve 52, and a hose or like conduit 54 connects a port 56 of the second chamber 46 of the cylinder body 34 in fluid communication with the port 20 of the upper form 14 via a valve 58. In the illustrated embodiment, the first chamber 44 is used for purposes of drawing a vacuum within the lower mold 16 and the second chamber 46 is used for purposes of providing an air blast within the upper mold 18. Of course, these functions can be re-designed and reversed, as desired.

In use, at least a portion of the stock sheet material 12 is heated and then positioned between the forms, 14 and 16, and thereafter, the forms, 14 and 16, are moved into the closed position in which the heated sheet material 12 is pinched in place between the forms, 14 and 16. In this engaged position, the material 12 cannot move relative to the forms, 14 and 16, and a fluid-tight seal is created between the material 12 and the forms, 14 and 16.

After the forms 14 and 16 of the forming station apparatus 10 are positioned in the closed position about the thermoplastic sheet material 12, the cylinder piston 32 is moved away (in a downward direction as viewed in FIG. 1) from its “home position”, which is the position illustrated in FIG. 1. As discussed above, the movable piston 32 divides the sealed cylinder body 34 and defines the opposite chambers, 44 and 46, and the cylinder body 34 includes ports 50 and 56 that communicate via valves 52 and 58 with air ports 20 and 26 in the upper and lower forms, 14 and 16.

Accordingly, movement of the piston 32 within the cylinder body 34 results in the generation of an air blast, a vacuum, or both. For example, as the piston 32 moves away from the home position (in a downward direction as viewed in FIG. 1) an air blast is delivered via the second chamber 46 due to a reduction of its volume and a vacuum is simultaneously drawn by the expansion of the first chamber 44. Thus, the sheet material 12 is pushed by the air blast applied to the void space 22 in the upper form 14 and pulled by suction applied via the vacuum drawn in the void space 28 in the lower form 16 such that the sheet material is forced to conform to the inner mold surface of the lower form 16. Thus, as viewed in FIG. 1, the sheet material 12 is pushed/pulled downwardly into engagement with the mold cavity surface of the lower form 16.

The generator 30 according to the present invention ensures equalization of the amount of push/pull on the material sealed between the opposite forms, 14 and 16. For example, the air displaced by the reduction of the volume of chamber 46 is equal to the air displaced in the void area 28 in the lower form and the increase in volume of the chamber 44. This ensures an appropriate amount of air blast needed to force the sheet material 12 into conformance with the mold surface, but also limits the air blast to prevent the forms, 14 and 16, from being undesirably blown apart due to an over application of air blast. Thus, the generator 30 is self-limiting without the need of other control mechanisms to limit the air blast. In addition, the generator 30 is self-adjusting in that it can be used with different sized forms requiring different volumes of air displacement without requiring any adjustment.

After the sheet material conforms to the mold cavity surface 60 of the lower form 16, the forms 14 and 16 are separated to expose the molded piece. The piston 32 is moved back to its home position in an opposite resetting direction (in an upward direction as viewed on FIG. 1) via a mechanical, electro-mechanical, or hydraulic mechanism. This movement can be precisely timed to start prior to, simultaneously with, or shortly after the opening of the forms, 14 and 16. The air blast generated during this movement can be used to eject the molded thermoforming material from the lower mold 16.

The valve system of the present invention can be controlled to provide only an air-blast to one of the forms, only a vacuum to one of the forms, or a combination of both an air blast and vacuum simultaneously to opposite forms. For example, a shallow packaging product may be capable of being formed with only an air blast or suction; whereas, a relatively deep drawn packaging product may require the simultaneous application of an air blast and vacuum. Accordingly, the forming 4station apparatus 10 provides flexibility in that it can readily form shallow packages as well as deep-drawn packages.

Accordingly, the present invention provides a small, self-contained, relatively inexpressive, and robust forming station and method of providing compressed air and vacuum to the forming station for a thermoforming/vacuum forming packaging machine. The invention provides the above while providing an economical and safe method of manufacturing a relatively small, “table top” packaging machine. The generator 30 eliminates the need for loud, expensive and potentially dangerous air compressor and vacuum sources. The piston/cylinder generator also provides equalization between air blast and vacuum and is both self-limiting and self-adjusting. This enables improved molding of sheet material, and it also enables less complexity and expense with respect to the structural mechanism clamping the forms together. For example, since the air blast is self-limited to the vacuum being drawn, an over amount of compressed air will never occur thereby eliminating a safety hazard. Further, forms of different sizes and shapes requiring different amounts of air displacement can be used without any need to make adjustments to the generator 30.

While preferred apparatus and methods have been described in detail, various modifications, alterations, and changes may be made without departing from the spirit and scope of the apparatus and methods according to the present invention as defined in the appended claims.

1. A forming station of a thermoforming and/or vacuum forming machine, comprising:
at least first and second opposed forms positionable in open and closed positions, in said closed position said forms creating a sealed mold with a mold cavity surface, each of said forms having a port communicating with an interior of said mold; and
a combination compressed fluid and vacuum generator including a fluid-tight hollow body and a piston moveable within said hollow body, said piston being in fluid-tight engagement with walls of said hollow body and defining opposite first and second chambers within said hollow body, each chamber being sealed from said other chamber and having a port;
said port of said first form being in fluid communication with said port of said first chamber, and said port of said second form being in fluid communication with said port of said second chamber;
whereby movement of said piston within said hollow body causes at least one of fluid to be forced into one of said forms of said mold, fluid to be drawn out of one of said forms of said mold, or both.

2. A forming station according to claim 1, further comprising a first valve between said port of said first form and said port of said first chamber, and a second valve between said port of said second form and said port of said second chamber.

3. A forming station according to claim 2, further comprising at least one conduit for connecting said port of said first form to said port of said first chamber with said first valve being connected therebetween, and at least one conduit for connecting said port of said second form to said port of said second chamber with said second valve being connected therebetween.

4. A forming station according to claim 2, wherein at least one of said first and second forms defining a void space adjacent said mold cavity surface, said void space being filled with a predetermined volume of fluid and defining a volume of fluid to be displaced by said generator via at least one of a fluid blast and suction.

5. A forming station according to claim 4, wherein said generator is a compressed gas and vacuum generator and wherein said generator is self-limiting and self-adjusting in that maximum gas displacement provided by said generator is automatically limited and adjusted to the volume of air in said void space within said mold.

6. A forming station according to claim 5, wherein said first and second forms include upper and lower forms, and wherein, in said open position, a sheet of thermoplastic material is positionable or advancable between said upper and lower forms.

7. A forming station according to claim 5, further comprising mounts for connecting said first and second forms to a structure of said forming station, and wherein said generator is mounted to said structure of said forming station.

8. A forming station according to claim 5, wherein said piston includes a piston plug in fluid-tight engagement with said walls of said hollow body and a stem extending from said plug through an end wall of said hollow body in a fluid-tight manner.

9. A forming station according to claim 8, wherein said hollow body is cylindrical and movement of said piston within said hollow body is along a longitudinal axis of said hollow body.

10. A forming station according to claim 1, wherein said forming station is a table-top forming station that does not require connection to an external source of compressed air or vacuum.

11. A method of thermoforming or vacuum forming a sheet of thermoplastic stock material in a forming station of a thermoforming and/or vacuum forming machine, comprising the steps of:
positioning at least first and second opposed forms of the forming station in an open position;
positioning or advancing the sheet of thermoplastic stock material between the first and second opposed forms when the first and second opposed forms are in the open position;
closing the first and second opposed forms in a fluid-tight closed position with the sheet of thermoplastic stock material captured therebetween adjacent a mold cavity defining a void space and mold cavity surface in one of said first and second opposed forms;
moving a piston within a hollow gas-tight body that has a first chamber on one side of the piston and a second chamber on an opposite side of the piston, movement of the piston within the hollow body generating a blast of gas via a port in one of the chambers and drawing a vacuum via a port in the other one of the chambers; and
applying the blast of gas, the vacuum, or both generated by said piston moving step to at least one of the forms to blow, draw, or both the sheet of thermoplastic stock material into conformance with the mold cavity surface.

12. A method according to claim 11, wherein the hollow body is integrally mounted to the forming station and wherein the forming station is sized to be positioned on a table top surface, and further comprising the step of positioning the forming station on a table-top surface, whereby the forming station is operable without connection to an external source of compressed gas or vacuum.

13. A method according to claim 11, wherein, during said applying step, the blast of gas generated by volume reduction of one of the chambers is applied to one of the forms on one side of the sheet of thermoplastic stock material and the vacuum generated by a volume expansion of the other one of the chambers is applied to the other one of the forms on an opposite side of the sheet of thermoplastic material to simultaneously both push and pull the sheet of thermoplastic material into conformance with the mold cavity surface.

14. A method according to claim 13, wherein during said applying step, the volume reduction and the volume expansion of the first and second chambers are substantially equal and thereby the volume of gas displacement caused by the blast of gas is substantially equal to the volume of gas displacement drawn by the vacuum.

15. A method according to claim 11, wherein the blast of gas and vacuum generated by said piston moving step within the hollow body is self-limiting and self-adjusting in that maximum gas displacement is automatically limited and adjusted to the volume of gas in the void space within the mold.

16. A method according to claim 11, further comprising the step of controlling said applying step with a valve system that controls the application of the blast of gas and vacuum to the forms.

17. A method according to claim 16, wherein the sheet of thermoplastic stock material is heated before said applying step.

18. A method according to claim 11, further comprising the step of ejecting the molded sheet of thermoplastic stock material from the mold cavity surface with a blast of gas generated by reversing movement of the piston within the hollow body.
